(19) United States
(12) Patent Application Publication
(10) Pub. No.: US 2014/0229952 A1
(43) Pub. Date: Aug. 14, 2014

(54) INTELLIGENT TASK MANAGER USING ONBOARD SENSORS

(71) Applicant: QUALCOMM INCORPORATED, San Diego, CA (US)

(72) Inventors: Mohit Anand, San Diego, CA (US); Babak Forutanpour, Carlsbad, CA (US); Michelle M. Cheung, San Diego, CA (US); Timothy K. Kerssen, San Diego, CA (US)

(73) Assignee: QUALCOMM Incorporated, San Diego, CA (US)

(21) Appl. No.: 13/765,573

(22) Filed: Feb. 12, 2013

(51) Int. Cl. G06F 9/46

(52) U.S. Cl. CPC G06F 9/46
USPC 718/102; 718/100

(57) ABSTRACT

A task manager that intelligently kills and/or launches processes on a mobile device based on the current state or transitions between states of the device is described. The task manager determines the current state of the mobile device and retrieves process settings associated with the detected current state and transitions between states from a state database. The process settings indicate historical process usage habits for the user of the mobile device while in and while entering and leaving the current state. Upon retrieving the process settings corresponding to the detected current state and state transitions, the task manager applies the process settings to kill or launch one or more processes on the mobile device.

### BACKGROUND

Aspects of the disclosure relate generally to a task manager that intelligently kills and/or launches processes on a mobile device based on the current state of the device. In particular, the task manager kills and/or launches processes based on heuristic use data and/or data from onboard sensors indicating the state of the mobile device.

Mobile devices, such as smartphones and personal digital assistances, may run applications and processes (hereinafter “processes”) created by various sources. Many of these processes are poorly designed and continue running in the background even after a user has attempted to close or terminate the process. Processes running in the background may consume power and network bandwidth, which results in reduced battery life of the mobile device and potentially increased data rate charges from a network carrier. Existing task managers automatically kill processes indiscriminately without awareness for the surroundings of the mobile device or the usage habits of the user. By arbitrarily killing processes, existing task managers impair usability and the overall user experience of mobile devices.

### BRIEF SUMMARY

An embodiment of the invention is directed to a task manager that intelligently kills and/or launches processes on a mobile device based on the current state, or transitions between states, of the device. The task manager detects the current state of the mobile device and retrieves process settings associated with the detected current state, or transitions between states, from a state database. The process settings indicate historical process usage habits for the user of the mobile device while in, entering, or leaving, the current state as well as in anticipation of entering a particular state. For example, the process settings may indicate that the user commonly accesses emails while in a business meeting state. Upon retrieving the process settings corresponding to the detected current state, the task manager applies the process settings to kill and/or launch one or more processes on the mobile device. For example, if the user historically checks his Facebook® page immediately prior to entering a meeting, the task manager may launch a Facebook® application when a meeting is scheduled to begin within several minutes and when the current location and direction of the mobile device indicate the user is headed to the meeting.

Another embodiment is directed to a method for managing processes on a mobile device, comprising: determining a current state of the mobile device; retrieving process settings associated with the current state from a state database, wherein the process settings are based at least in part on process usage habits for a user of the mobile device while in the current state; and applying the process settings associated with the current state to kill one or more processes running on the mobile device.

Another embodiment is directed to a mobile device, comprising: a processor; one or more sensors for detecting a current state of the mobile device; and a task manager for retrieving one or more process settings corresponding to the current state of the mobile device and applying the one or more retrieved process settings to kill one or more of the processes.

Another embodiment is directed to a machine-readable medium comprising instructions, which, when executed by a machine, cause the machine to perform operations, the instructions comprising: determine a current state of the mobile device; retrieve process settings associated with the current state from a state database, wherein the process settings indicate process usage habits for a user of the mobile device while in the current state; and apply the process settings associated with the current state to kill one or more processes running on the mobile device.

Another embodiment is directed to a method for managing processes on a mobile device, comprising: detecting a transition from a first state of the mobile device to a second state; retrieving process settings associated with the transition between the first and second states from a state database, wherein the process settings indicate process usage habits for a user of the mobile device before and after the transition between the first and second states; and applying the process settings associated with the transition between the first and second states to kill one or more processes running on the mobile device.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 shows a wireless communication system with multiple mobile devices in accordance with various embodiments of the invention;

FIG. 2 shows a component diagram of a mobile device according to one embodiment of the invention; and

FIG. 3 shows a method for intelligently managing processes on a mobile device according to one embodiment of the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items. The word “exemplary” is used herein to mean “serving as an example, instance, or illustration.” Any embodiment or design described herein as “exemplary” is not necessarily to be construed as preferred or advantageous over other embodiments or designs

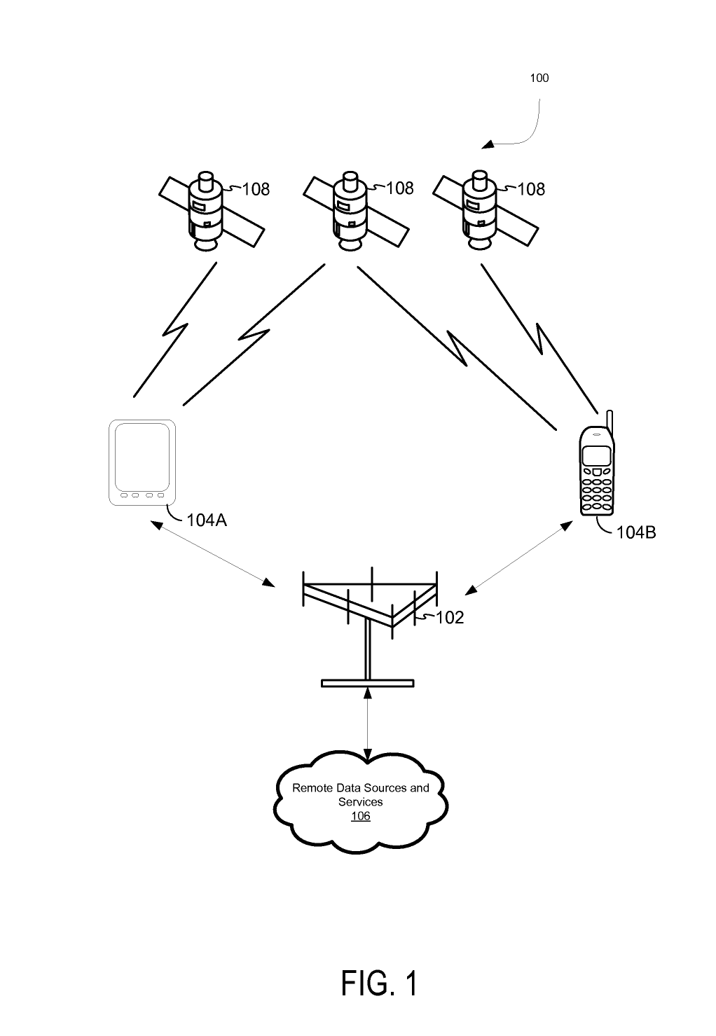

FIG. 1 shows a wireless communication system 100 in accordance with various embodiments presented herein. System 100 comprises a base station (e.g., an access point) 102 that can include multiple antenna groups. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices 104 such as mobile device 104A and mobile device 104B. However, it is to be appreciated that base station 102 can communicate with substantially any number of mobile devices 104 similar to mobile devices 104A and 104B. Mobile devices 104A and 104B can be, for example, cellular phones, smart phones, laptops, handheld communication devices, handheld computing devices, satellite radios, satellite positioning systems (SPSs), personal digital assistants (PDAs), and/or any other suitable device for communicating over wireless communication system 100. As depicted, mobile device 104A is a tablet computer while mobile device 104B is a mobile telephone.

Base station 102 may facilitate communications between mobile devices 104 and remote data sources and services 106. Remote data sources 106 may include remote servers, remoter networks, and other mobile devices 104 coupled to other networks and systems.

Mobile devices 104A and 104B may utilize any set of protocols and mediums for communicating with base station 102 and with each other. For example, wireless communication system 100 may be a wireless cellular network (e.g., a code division multiple access (CDMA) network, a time division multiple access (TDMA) network, a 3GPP Long Term Evolution (LTE) network, etc.), a wireless local data network (e.g., an IEEE 802.11x network), or any other network (e.g., a Transmission Control Protocol and Internet Protocol (TCP/IP) network). Although shown as communicating through the base station 102, in some embodiments mobile devices 104A and 104B may directly exchange data without interaction with base station 102. For example, mobile devices 104A and 104B may directly communicate with each other using a Bluetooth connection.

Mobile devices 104A and 104B may also communicate with one or more satellite positioning systems (SPSs) 108 as shown in FIG. 1. SPSs 108 typically include a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass). In accordance with certain aspects, the techniques presented herein are not restricted to global systems (e.g., GNSS) for SPSs 108. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein SPSs 108 may include any combination of one or more global and/or regional navigation satellite systems and/or augmentation systems, and SPS signals may include SPS, SPS-like, and/or other signals associated with such one or more SPS.

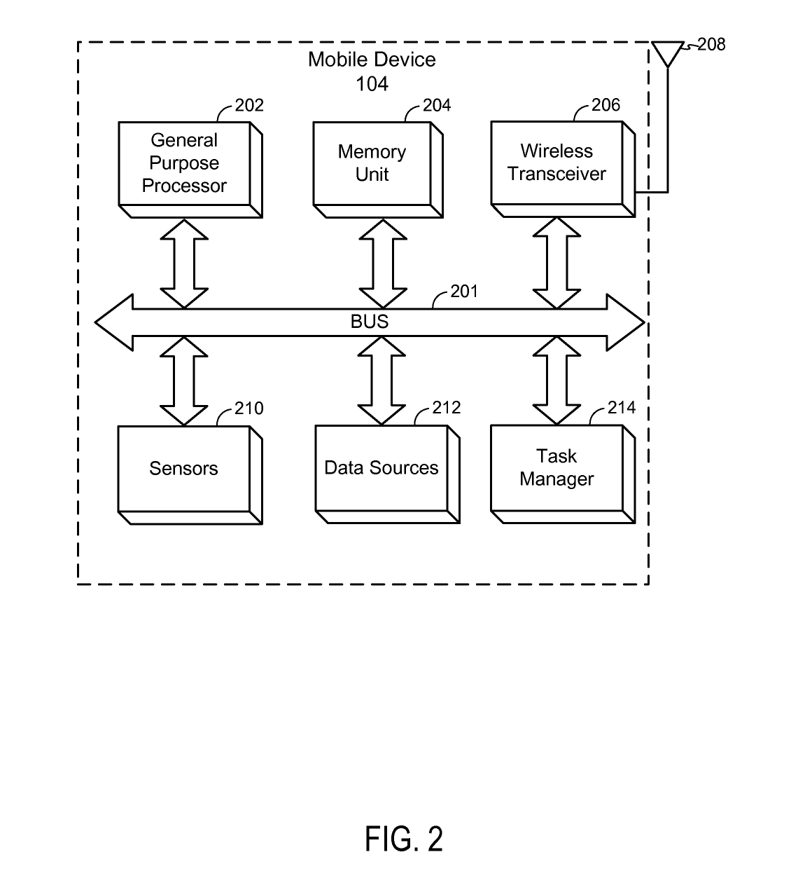

Turning now to FIG. 2, a mobile device 104 according to one embodiment is shown. Mobile device 104 shown in FIG. 2 includes several example components. In other embodiments, mobile device 104 may include other components not shown. Each of the components may be coupled to bus 201. Bus 201 transfers data and other signals between components within mobile device 104. Bus 201 may be any type of transport medium. For example, bus 201 may be a peripheral component interconnect (PCI) bus, a PCI express (PCIe) bus, a serial advanced technology attachment (SATA) bus, a parallel advanced technology attachment (PATA) bus, a HyperTransport bus, an industry standard architecture (ISA) bus, or any other similar type of bus.

In one embodiment, mobile device 104 includes a general purpose processor 202 and a memory unit 204 for processing and storing data. Processor 202 and memory unit 204 are generically used here to refer to any suitable combination of programmable data processing components and data storage that conduct the operations needed to implement the various functions and operations of mobile device 104. Processor 202 may be an applications processor typically found in a smart phone, while memory unit 204 may refer to microelectronic, non-volatile random access memory. An operating system may be stored in memory unit 204, along with application programs specific to the various functions of mobile device 104, which are to be run or executed by processor 202 to perform the various functions of mobile device 104.

Although not shown, mobile device 104 may include a battery, which is the primary power source for mobile device 104. The battery may be of any type capable of being integrated within or coupled to mobile device 104. For example, the battery may be a lithium-ion battery, a potassium-ion battery, a nickel-cadmium battery, a fuel cell battery, or any other similar type of battery. The battery may be rechargeable through a power/data connector exposed to an outer surface of mobile device 104.

Mobile device 104 may also include wireless transceiver 206 with a corresponding antenna 208. Wireless transceiver 206 may be any network communications component capable of receiving and transmitting data through a distributed or a point-to-point network (e.g., wireless communication system 100). For example, transceiver 206 may be capable of communicating with other mobile devices 104 or base station 102 of FIG. 1 using one or more of CDMA, TDMA, LTE, IEEE 802.11x, or Bluetooth protocols.

In one embodiment, mobile device 104 includes various sensors 210 and data sources 212 for detecting and monitoring the current state of mobile device 104. The current state may be detected by polling or retrieving sensed data from one or more sensors 210 and data sources 212. In one embodiment, sensors 210 and data sources 212 may include one or more of an ambient light sensor, a camera, an accelerometer, a gyroscope, a touchscreen, a capacitive proximity sensor, an infrared proximity sensor, a SPS sensor, a battery level sensor, a Bluetooth transceiver, a Near Field Communications transceiver, a barometer, a thermometer, a microphone, a clock, and an appointment calendar. In other embodiments, mobile device 104 may include additional sensors 210 and data sources 212 for detecting the state of mobile device 104.

As noted above, sensors 210 may be used to capture the state of mobile device 104. The state may be represented as a set of data values from one or more sensors 210 and data source 212. For example, the current state of mobile device 104 may be represented as a tuple of data readings from a SPS transceiver, an accelerometer, and a barometer. In this example, the data tuple corresponding to the current state of mobile device 104 may be represented as position coordinates from the SPS transceiver, an acceleration value from the accelerometer, and a barometric pressure value from the barometer.

The mobile device may include task manager 214 for managing processes or applications (hereinafter “processes”) running on mobile device 104 based on the detected current state of mobile device 104. As used herein, a process is an instance of a computer program that is being executed by processor 202.

In one embodiment, task manager 214 may be an application or process stored in memory unit 204 and run by general purpose processor 202. In another embodiment, task manager 214 may be implemented by a standalone set of processors, memory units, and/or other hardware components within mobile device 104.

Task manager 214 kills/terminates processes that are less likely to be used by a user of mobile device 104 during the detected current state. For example, a running process on mobile device 104 is killed if task manager 214 determines that the user has less than a predefined probability of using the process in a predefined future time period. In one embodiment, task manager 214 determines the probability a process will be used based on recorded historical/heuristic usage statistics for the corresponding state. Managing processes based on a historical/heuristic analysis of use of mobile device 104 in a variety of states, or while transitioning between states, improves battery life, reduces network data usage, and enhances the overall user experience.

Killing a process is defined as the termination of the process such that all associated threads are removed from memory unit 204 and/or are no longer active with processor 202. Killing a process may be performed by sending a kill signal directly to the process or indirectly through another component of mobile device 104. For example, task manager 214 may invoke a kill, pkill, or xkill command to send a SIGTERM or SIGKILL signal to a process designated to be killed.

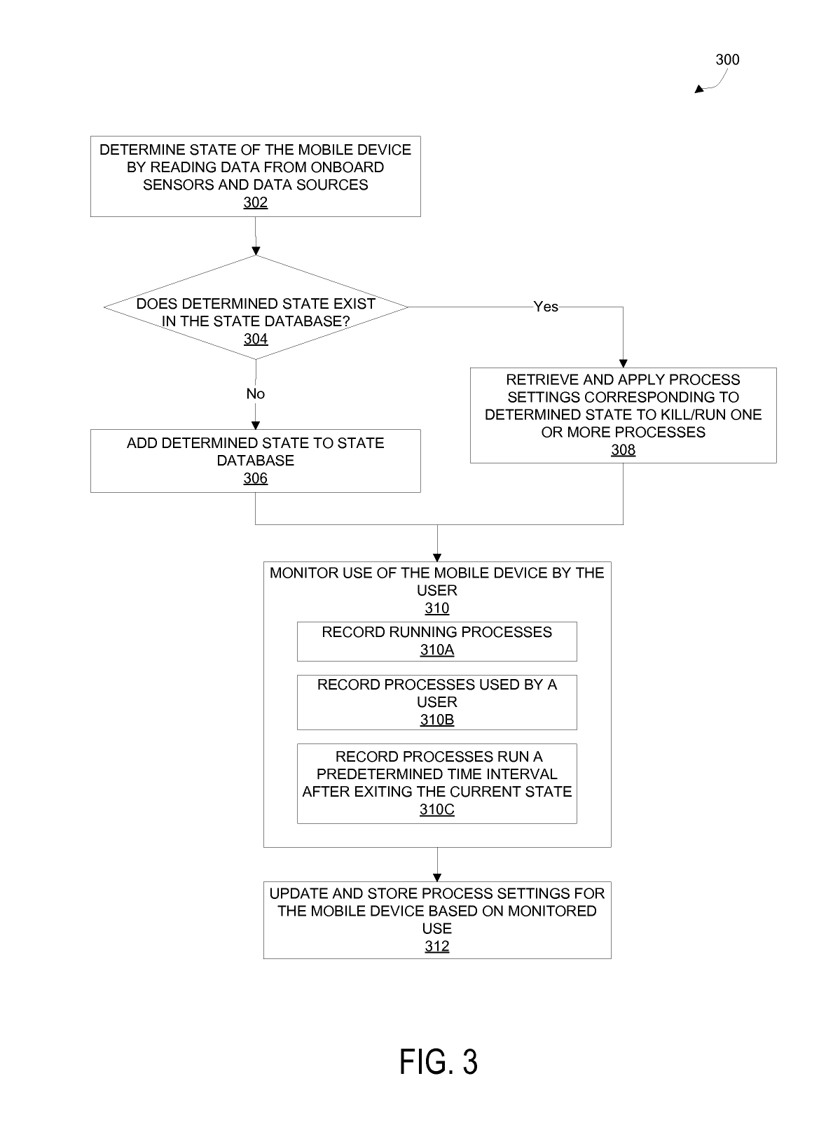

FIG. 3 shows an example method 300 used by task manager 214 for managing processes based on a historical/heuristic analysis of process use in a variety of states. Task manager 214 may perform method 300 using one or more additional components of mobile device 104 (e.g., processor 202, memory unit 204, sensors 210, data sources 212, etc.).

The method 300 begins at operation 302 with the detection of the current state of mobile device 104. The current state may be determined by polling or retrieving data from one or more sensors 210 or data sources 212 integrated within or otherwise accessible to mobile device 104. As noted above, sensors 210 and data sources 212 may include one or more of an ambient light sensor, a camera, an accelerometer, a gyroscope, a touchscreen, a capacitive proximity sensor, an infrared proximity sensor, a SPS sensor, a battery level sensor, a Bluetooth transceiver, a Near Field Communications transceiver, a barometer, a thermometer, a microphone, a clock, and an appointment calendar. In other embodiments, mobile device 104 may include additional sensors 210 and data sources 212 for detecting the state of mobile device 104.

The detected state represents the conditions in which mobile device 104 is operating and/or the method by which the user is using device 104. For example, an accelerometer may indicate that the mobile device 104 is motionless, an ambient light sensor may indicate that the mobile device is in a dark room, and a clock may indicate that it is late at night (e.g., 11:00 PM). In this situation, the current state is the user being asleep.

In another example, capacitive grip sensors may detect flesh or an accelerometer may detect slight involuntary hand tremors. In this situation, the current state is the mobile device 104 in the hand of the user.

In another example, an ambient light sensor may detect a low light level, a capacitive grip sensor on the sides of the mobile device 104 may not detect flesh while capacitive sensors on the back face of the mobile device 104 detect a large object (e.g., a leg of the user). In this situation, the current state is the mobile device 104 is in a pocket of the user. This example state may be augmented by analyzing readings from an accelerometer. For instance, when an accelerometer detects rapid movement along with the above other sensor readings, the current state may be the mobile device 104 in the pocket of the user while the user is walking or running.

In another example, an accelerometer detects rapid movement and a microphone detects the absence of echoes (indicating a small room). In this situation, the current state is the mobile device 104 in a car in motion.

In still another example, a SPS sensor may determine that mobile device 104 is at a shopping mall, an accelerometer along with a barometer may indicate that mobile device 104 is moving rapidly upwards in an elevator, and an appointment calendar along with a clock may indicate that the user is headed to a lunch meeting in the food court of the shopping mall. In this situation, the detected current state is a user of mobile device 104 in the elevator of a shopping mall and headed to a lunch meeting. In another example, a microphone may be used to pick up voices in a business meeting while a camera along with a light sensor may respectively show a dark image and a low light level indicating mobile device 104 is in the user's pocket or bag. In this situation, the detected current state is a user in a business meeting with mobile device 104 packed away.

Although described textually, detected states may be represented by a set of sensor readings or ranges of readings. For example, a detected current state may be represented by the following data structure:

```
currentState
{
  currentLocation = 10800 West Pico Blvd., 90064,
  currentAcceleration = 1.5,
  currentAccelerationDirection = 90,
  currentBarometricPressure = 100,
  nextMeetingTime= 1200,
  nextMeetingLocation = 10800 West Pico Blvd., 90064,
  currentTime = 1159
}
```

As shown in this example data structure, the currentLocation variable is an address received from a SPS sensor and corresponding to a shopping mall, the currentAcceleration variable is a numerical value received from an accelerometer indicating acceleration at 1.5 meters/second2, the currentAccelerationDirection is a numerical value received from the accelerometer indicating acceleration at 90 degrees (i.e., upwards), the currentBarometricPressure variable is a numerical value received from a barometer indicating a higher than normal barometric pressure of 100 cm, the nextMeetingTime variable is a numerical value from a calendar indicating that the user's next meeting is at 1200 hours, the nextMeetingLocation variable is a string value from the calendar indicating that the next meeting is at 10800 West Pico Blvd., 90064, and the currentTime variable is a numerical value from a clock indicating that the current time is 1159 hours. The currentState data structure indicates that the detected current state is a user of the mobile device in the elevator of a shopping mall and headed to a lunch meeting. In other embodiments, the current state may be represented using different data structures, variables, and data sources.

In another example, a detected current state may be represented by the following data structure:

```
currentState
{
  currentLightLevel = 4,
  currentAcceleration = 0,
  currentTime = 2330
}
```

As shown in this example data structure, the currentLightLevel variable is a numerical value received from an ambient light sensor with a value of 4 lux, the currentAcceleration is a numerical value received from an accelerometer indicating acceleration at 0 meters/second2, and the currentTime variable is a numerical value from a clock indicating that the current time is 2330 hours. The currentState data structure indicates that the detected current state is the user being asleep.

Upon the detection of the current state, the method 300 moves to operation 304 to determine if the detected current state exists in a state database. The state database is a listing of the previously detected states and corresponding process settings. The determination or the matching of the current state with a previous state may be performed with a subset of the sensor data. In some embodiments, the determination or the matching of the current state with a previous state may be performed within a set of specified tolerances. For example, a light level value from an ambient light sensor in a current state may fall within a specified range of readings to be considered represented by a previously detected state. For instance, using the sample current state above in which the user is asleep, this state may be matched with a state in which the currentLightLevel variable is 3 lux, the currentAcceleration is 0 meters/second2, and the currentTime variable is 0120 hours. This variance in sensor readings allows for a more robust characterization of the current states of the mobile device 104.

The process settings indicate which processes to kill/terminate based on a heuristic analysis of previous use of mobile device 104. For instance, in a business meeting state, the process settings may indicate that all running processes not in active use should be killed, except for an email process. As will be described in further detail below, the process settings for each state have been generated based on previous use of mobile device 104 in corresponding states. Thus, in the example above, only the email process remains active while all other processes not in active use are killed, because historically the user periodically checks emails during the business meeting state, but rarely uses other processes on mobile device 104 while in the business meeting state.

As noted above, operation 304 does not kill/terminate processes that are running on mobile device 104 and are in active use (i.e., currently being used by the user and/or are in the foreground of mobile device 104 such that an associated interface of the process may be visible to the user). In one embodiment, the process settings also do not prevent processes from being manually launched at any time by the user. As described above, these active processes are not subject to being killed based on the process settings. In one embodiment, process settings for a corresponding state in which a process was manually launched are updated to reflect the preference of the user to use the manually launched process during the associated state.

Although described primarily as killing processes, in one embodiment the process settings may indicate processes to launch when entering a detected state. For example, the process settings may indicate that an email process should be launched when entering a business meeting state. By launching the email process, method 300 ensures that previous killing operations for a previous state do not affect usability of mobile device 104 in the current state.

In some embodiments, the process settings for each state may be organized into different intensity levels. The intensity levels indicate how aggressively processes will be killed based on the current settings or characteristics of mobile device 104. For example, using a high intensity level will result in more processes being killed. In contrast, using a low intensity level will result in less processes being killed. In one embodiment, choice of intensity level is determined based on one or more of battery power level, time of day, day of the week, location of mobile device 104, and user preference. For example, a high intensity level may be used when the battery power level of mobile device 104 is low and it is early in the day. Using the high intensity level will result in more processes being killed and battery life preserved. In contrast, a low intensity level may be used when the battery power level of mobile device 104 is high and it is late in the day. Using the low intensity level will improve usability of device 104 as processes will remain running at the possible expense of battery life, which is relatively abundant. The table below shows process settings for a state with three intensity levels. In one embodiment, the user may also wish to trade some level of responsiveness in order to preserve battery life of the mobile device 104. In this embodiment, the method 300 may allow the user to adjust the intensity level to a lower level to enhance the user's experience. For example, the user may manually shift the mobile device 104 from Level 3 shown in the table below to Level 1. This shift downwards causes the method 300 to kill fewer processes, which in turn may improve waiting/loading times for processes running on the mobile device 104.

Processes to Kill

| State | Level 1 | Level 2 | Level 3 |
|---|---|---|---|
| Business | Games | Games | Games |
| Meeting State | | Web-Browser | Web-Browser |
| | | | EMAIL |

If it is determined at operation 304 that the current state is not in the state database, the current state is added at operation 306. Otherwise, if the current state is already in the state database, operation 308 retrieves corresponding process settings from the state database and applies these process settings to mobile device 104 to kill processes historically unused during the current state.

Upon adding the current state to the state database or retrieving process settings for the current state from the state database, the process moves to operation 310 to monitor the use of mobile device 104 by the user. Monitoring the use of mobile device 104 assists in updating the process settings for the current state, which indicate processes that should be killed. In one embodiment, operation 310A records a listing of running process on mobile device 104. For example, an email process, a web-browser process, and a game process may be recorded as running on mobile device 104 upon entering a particular state or after applying process settings for the current state.

In one embodiment, operation 310B records processes actually used by the user while in the current state. For example, operation 310B may detect and record that the user sent an email using the email process while in the current state. The detection of use may include the duration of use, power consumption, and other characteristics of the use. Recordation of used processes may include processes previously recorded as running at operation 310A or new processes launched by the user while in the current state. For example, the user may launch a social networking application (e.g., a Facebook® application) that was not previously running at operation 310A. As will be described in further detail below, detecting processes used by the user while in the current state will assist in updating or otherwise generating process settings for the current state. For example, although historically the user uses a web browser process while in meetings, the user may shy away from this practice. Accordingly, process settings for states in which the user is in a meeting may be updated to kill the web-browser process as the web-browser is no longer commonly used during meetings.

In one embodiment, processes active on mobile device 104 during the transition between states are not killed and are considered as processes that are actually used by the user while in the current state. By being flagged as actually used, processes active on mobile device 104 during the transition between states remain active and will be updated in corresponding process settings to have a reduced likelihood of being killed and an increased likelihood of being launched during similar future transitions between states.

In one embodiment, operation 310C records processes run after mobile device 104 has exited from the current state. The recordation may be limited to a predefined time interval following a change of state. For example, after leaving a business meeting state operation 310C may record all processes launched in the ensuing five minute period. This listing of launched processes may be used to alter the process settings of the recently exited state. For instance, two minutes after exiting a business meeting state the user may launch a web-browser process. Operation 310C records and associates this process launch with the business meeting state such that the process settings may be updated to be less inclined to kill the web-browser process during the business meeting state, or launch the web-browser process, if it is not currently running, immediately upon exiting the business meeting state.

After or concurrent with monitoring use of mobile device 104 at operation 310, the process settings for the current state are generated/updated. As described above, the process settings reflect the historic preferences of the user regarding processes running on mobile device 104 while in each state. In the example process settings shown in the table above, the user is likely to use an email process while in a business meeting state. This is reflected by the fact that the email process is only designated to be killed while at a high intensity level (i.e., Level 3). However, if this preference to use an email process while in the business meeting state is replaced by a preference to use a game process, the table may be updated as shown below.

Processes to Kill

| State | Level 1 | Level 2 | Level 3 |
|---|---|---|---|
| Business Meeting | EMAIL | EMAIL | EMAIL |
| State | | Web-Browser | Web-Browser |
| | | | Games |

As noted above, managing processes based on a heuristic analysis of use of mobile device 104 in a variety of states improves battery life, reduces network data usage, and enhances the overall user experience for mobile device 104. In particular, processes less likely to be used by the user during a detected state are killed/terminated to improve battery life and reduce network usage while applications more likely to be used are retained and/or launched to ensure lag/startup time

As used herein, a mobile station (MS) or a mobile device refers to a device such as a cellular or other wireless communication device, personal communication system (PCS) device, personal navigation device (PND), Personal Information Manager (PIM), Personal Digital Assistant (PDA), laptop, tablet or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

The methodologies described herein may be implemented by various means depending upon the application. For example, these methodologies may be implemented in hardware, firmware, software, or any combination thereof. For an implementation involving hardware, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation involving firmware and/or software, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processing unit. Memory may be implemented within the processing unit or external to the processing unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processing units to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

What is claimed is:

1. A method for managing processes on a mobile device, comprising:
determining a current state of the mobile device;
retrieving process settings associated with the current state from a state database, wherein the process settings are based at least in part on process usage habits for a user of the mobile device while in the current state; and
applying the process settings associated with the current state to kill one or more processes running on the mobile device.

2. The method of claim 1, further comprising:
monitoring use of the mobile device by the user while in the current state; and
updating the process settings in the state database for the current state based on the monitored use of the mobile device.

3. The method of claim 2, wherein monitoring use of the mobile device comprises:
recording a list of processes running on the mobile device upon detection of the current state;
recording processes used by the user while in the current state; and
recording processes run a predetermined time interval after exiting the current state.

4. The method of claim 1, wherein the process settings for the current state include a listing of processes to kill during the current state.

5. The method of claim 4, wherein the listing of processes to kill during the current state is classified by intensity levels, wherein the intensity levels indicate a priority by which processes are killed based on the current settings or characteristics of the mobile device.

6. The method of claim 5, wherein the intensity levels are based on battery level of the mobile device.

7. The method of claim 1, wherein the current state of the mobile device is determined based on data from one or more sensors integrated within the mobile device.

8. The method of claim 7, wherein the sensors include one or more of an ambient light sensor, a camera, an accelerometer, a gyroscope, a touchscreen, a capacitive proximity sensor, an infrared proximity sensor, a global positioning system sensor, a battery level sensor, a Bluetooth transceiver, a Near Field Communications transceiver, a barometer, a thermometer, and a microphone.

9. The method of claim 1, further comprising:
applying the process settings associated with the current state to launch one or more processes on the mobile device.

10. A mobile device, comprising:
a processor;
one or more sensors for detecting a current state of the mobile device; and
a task manager for retrieving one or more process settings corresponding to the current state of the mobile device and applying the one or more retrieved process settings to kill one or more of the processes.

11. The mobile device of claim 10, wherein the task manager:
monitors use of the mobile device while in the current state and at transition boundaries of the current state; and
updates the process settings for the current state in a state database based on the monitored use of the mobile device.

12. The mobile device of claim 11, wherein the task manager monitors use of the mobile device by:
recording a list of processes running on the mobile device upon detection of the current state;
recording processes used by the user while in the current state; and
recording processes run a predetermined time interval after exiting the current state.

13. The mobile device of claim 10, wherein the one or more process settings for the current state include a listing of processes to kill during the current state.

14. The mobile device of claim 13, wherein the listing of processes to kill during the current state is classified by intensity levels, wherein the intensity levels indicate a priority by which processes are killed based on the current settings or characteristics of the mobile device.

15. The mobile device of claim 10, wherein the current state of the mobile device is detected based on one or more sensors integrated within the mobile device.

16. The mobile device of claim 14, wherein the intensity levels are based on battery level of the mobile device and on user preference.

17. The mobile device of claim 10, wherein the sensors include one or more of an ambient light sensor, a camera, an accelerometer, a gyroscope, a touchscreen, a capacitive proximity sensor, an infrared proximity sensor, a global positioning system sensor, a battery level sensor, a Bluetooth transceiver, a Near Field Communications transceiver, a barometer, a thermometer, and a microphone.

18. The mobile device of claim 10, wherein the task manager applies the process settings associated with the current state to launch one or more processes on the mobile device.

19. A machine-readable medium comprising instructions, which, when executed by a machine, cause the machine to perform operations, the instructions comprising:
determine a current state of the mobile device;
retrieve process settings associated with the current state from a state database, wherein the process settings indicate process usage habits for a user of the mobile device while in the current state; and
apply the process settings associated with the current state to kill one or more processes running on the mobile device.

20. The machine-readable medium of claim 19, the instructions further comprising:
monitor use of the mobile device by the user while in the current state; and
update the process settings in the state database for the current state based on the monitored use of the mobile device.

21. The machine-readable medium of claim 20, the instructions further comprising:
record a list of processes running on the mobile device upon detection of the current state;
record processes used by the user while in the current state; and
record processes run a predetermined time interval after exiting the current state.

22. The machine-readable medium of claim 19, wherein the process settings for the current state include a listing of processes to kill during the current state.

23. The machine-readable medium of claim 22, wherein the listing of processes to kill during the current state is classified by intensity levels, wherein the intensity levels indicate a priority by which processes are killed based on the current settings or characteristics of the mobile device.

24. The machine-readable medium of claim 23, wherein the intensity levels are based on battery level of the mobile device and on user preference.

25. The machine-readable medium of claim 19, wherein the current state of the mobile device is detected based on one or more sensors integrated within the mobile device.

26. The machine-readable medium of claim 25, wherein the sensors include one or more of an ambient light sensor, a camera, an accelerometer, a gyroscope, a touchscreen, a capacitive proximity sensor, an infrared proximity sensor, a global positioning system sensor, a battery level sensor, a Bluetooth transceiver, a Near Field Communications transceiver, a barometer, a thermometer, and a microphone.

27. The machine-readable medium of claim 19, further comprising:
applying the process settings associated with the current state to launch one or more processes on the mobile device.

28. A method for managing processes on a mobile device, comprising:
detecting a transition from a first state of the mobile device to a second state;
retrieving process settings associated with the transition between the first and second states from a state database, wherein the process settings indicate process usage habits for a user of the mobile device before and after the transition between the first and second states; and
applying the process settings associated with the transition between the first and second states to kill one or more processes running on the mobile device.

29. The method of claim 28, further comprising:
monitoring use of the mobile device by the user while transitioning between the first and second states; and
updating the process settings in the state database for the transition between the first and second states based on the monitored use of the mobile device.

30. The method of claim 29, wherein monitoring use of the mobile device comprises:
recording a list of processes running on the mobile device before and after transitioning between the first and second states;
recording processes used by the user before and after transitioning between the first and second states; and
recording processes run a predetermined time interval after transitioning between the first and second states.

31. The method of claim 28, wherein the process settings for the transition between the first and second states include a listing of processes to kill while transitioning between the first and second states.

32. The method of claim 31, wherein the listing of processes to kill during the transition between the first and second states is classified by intensity levels, wherein the intensity levels indicate a priority by which processes are killed based on the current settings or characteristics of the mobile device.

33. The method of claim 32, wherein the intensity levels are based on battery level of the mobile device and on user preference.

34. The method of claim 28, wherein the transition between the first and second states is detected based on one or more sensors integrated within the mobile device.

35. The method of claim 34, wherein the sensors include one or more of an ambient light sensor, a camera, an accelerometer, a gyroscope, a touchscreen, a capacitive proximity sensor, an infrared proximity sensor, a global positioning system sensor, a battery level sensor, a Bluetooth transceiver, a Near Field Communications transceiver, a barometer, a thermometer, and a microphone.

36. The method of claim 28, further comprising:
applying the process settings associated with the transition between the first and second states to launch one or more processes on the mobile device.

37. A mobile device, comprising:
a processing means;
one or more sensing means for detecting a current state of the mobile device; and
a task manager means for retrieving one or more process settings corresponding to the current state of the mobile device and applying the one or more retrieved process settings to kill one or more of the processes.

38. The mobile device of claim 37, wherein the task manager means:
monitors use of the mobile device while in the current state and at transition boundaries of the current state; and
updates the process settings for the current state in a state database based on the monitored use of the mobile device.

39. The mobile device of claim 38, wherein the task manager means monitors use of the mobile device by:
recording a list of processes running on the mobile device upon detection of the current state;
recording processes used by the user while in the current state; and
recording processes run a predetermined time interval after exiting the current state.

40. The mobile device of claim 37, wherein the one or more process settings for the current state include a listing of processes to kill during the current state.

41. The mobile device of claim 40, wherein the listing of processes to kill during the current state is classified by intensity levels, wherein the intensity levels indicate a priority by which processes are killed based on the current settings or characteristics of the mobile device.

42. The mobile device of claim 41, wherein the intensity levels are based on battery level of the mobile device and on user preference.

43. The mobile device of claim 37, wherein the current state of the mobile device is detected based on one or more sensors integrated within the mobile device.

44. The mobile device of claim 37, wherein the sensors include one or more of an ambient light sensor, a camera, an accelerometer, a gyroscope, a touchscreen, a capacitive proximity sensor, an infrared proximity sensor, a global positioning system sensor, a battery level sensor, a Bluetooth transceiver, a Near Field Communications transceiver, a barometer, a thermometer, and a microphone.

45. The mobile device of claim 37, wherein the task manager means applies the process settings associated with the current state to launch one or more processes on the mobile device.
